(19) United States
(12) Patent Application Publication
(10) Pub. No.: US 2026/0103159 A1
(43) Pub. Date: Apr. 16, 2026

(54) Vehicle Collision Impact Reduction Device

(71) Applicant: Marshall Franzman, Inver Grove Heights, MN (US)

(72) Inventor: Marshall Franzman, Inver Grove Heights, MN (US)

(21) Appl. No.: 18/914,925

(22) Filed: Oct. 14, 2024

(51) Int. Cl. B60R 19/20; E01F 15/04

(52) U.S. Cl. CPC B60R 19/20; E01F 15/0453

(57) ABSTRACT

A vehicle collision impact reduction device for reducing the force of an impact with a vehicle includes a tube defining an interior space that is designed to hold air. The tube has a pair of ends and is elongated between the pair of ends. A mount is coupled to each end of the pair of ends of the tube. The mount is designed to couple the tube to a structure. The tube is designed to absorb force from an impact with the structure. A cover is coupled to the tube. The cover includes a canvas material wherein the cover is designed to inhibit damage to the tube. A fill valve is coupled to the tube. The fill valve is in fluid communication with the interior space wherein the fill valve is designed to facilitate increasing an air pressure within the interior space.

### TITLE OF THE INVENTION

### Cross-Reference to Related Applications

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle collision safety devices and more particularly pertains to a new vehicle collision safety device for reducing the force of an impact with a vehicle.

### (2) Description of Related Art including information disclosed under 37 CFR 1.97 and 1.98

The prior art relates to vehicle collision safety devices. For example, seatbelts were designed to keep vehicle occupants secured within the cabin of a vehicle after a collision. Similarly, air bags have been installed within vehicles so that the air bags can deploy into the cabin of the vehicle to prevent occupants from being thrown out of the vehicle during collisions. However, such devices are imperfect. Although they can often retain the occupants within the vehicles, they function by forcefully impacting the bodies of the occupants themselves. For example, air bags can deploy at speeds of 200 miles per hour, hitting occupants'bodies with up to 2,600 pounds of force. Because of the positioning of air bags within the vehicle, such as being stored inside the steering wheel, dashboard, and roof lining, the air bags typically hit vehicle occupants in the face and head, causing head and neck injuries. Thus, there is a need for a device which can reduce the impact of a collision without injuring the occupants within the cabin of the vehicle.

### BRIEF SUMMARY OF THE INVENTION

An embodiment of the disclosure meets the needs presented above by generally comprising a tube defining an interior space that is configured to hold air. The tube has a pair of ends and is elongated between the pair of ends. A mount is coupled to each end of the pair of ends of the tube. The mount is designed to couple the tube to a structure wherein the tube is configured to absorb force from an impact with the structure. A cover is coupled to the tube. The cover includes a canvas material wherein the cover is configured to inhibit damage to the tube. A fill valve is coupled to the tube. The fill valve is in fluid communication with the interior space wherein the fill valve is configured to facilitate increasing an air pressure within the interior space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a vehicle collision impact reduction device according to an embodiment of the disclosure.

FIG. 2 is a detail isometric view of an embodiment of the disclosure.

FIG. 3 is a cross-sectional view of an embodiment of the disclosure.

FIG. 4 is a cross-sectional view of an embodiment of the disclosure.

FIG. 5 is a front isometric view of an embodiment of the disclosure.

FIG. 6 is a detail isometric view of an embodiment of the disclosure.

FIG. 7 is a cross-sectional view of an embodiment of the disclosure.

FIG. 8 is an in-use view of an embodiment of the disclosure.

FIG. 9 is an in-use view of an embodiment of the disclosure.

FIG. 10 is an in-use view of an embodiment of the disclosure.

FIG. 11 is an in-use view of an embodiment of the disclosure.

FIG. 12 is an in-use view of an embodiment of the disclosure.

FIG. 13 is an in-use view of an embodiment of the disclosure.

FIG. 14 is a detail isometric view of an embodiment of the disclosure.

FIG. 15 is a cross-sectional view of an embodiment of the disclosure.

FIG. 16 is a detail isometric view of an embodiment of the disclosure.

FIG. 17 is a cross-sectional view of an embodiment of the disclosure.

### DETAILED DESCRIPTION OF THE INVENTION

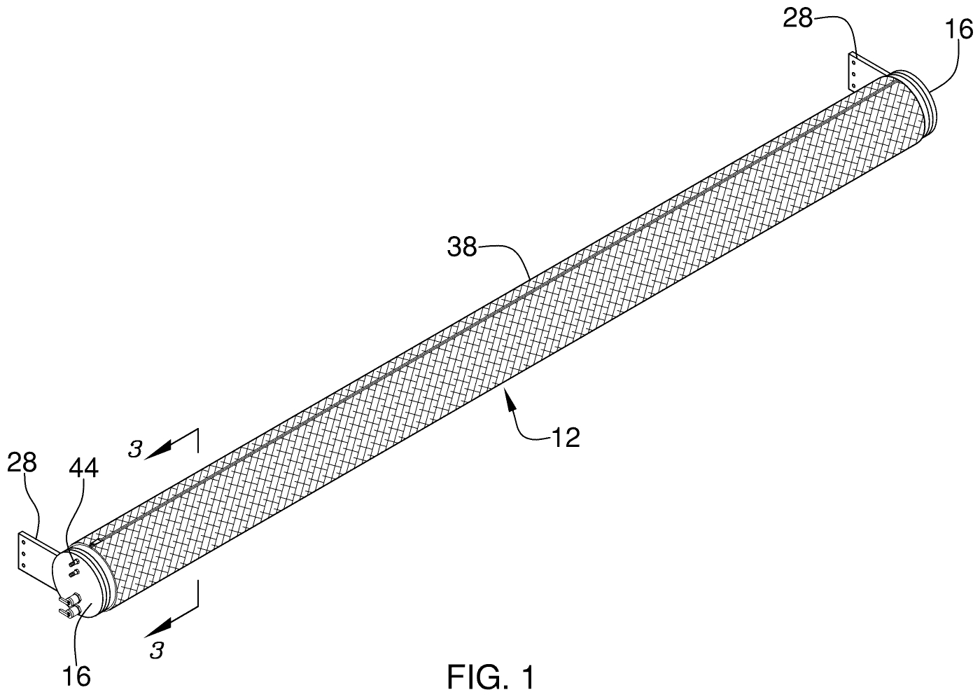

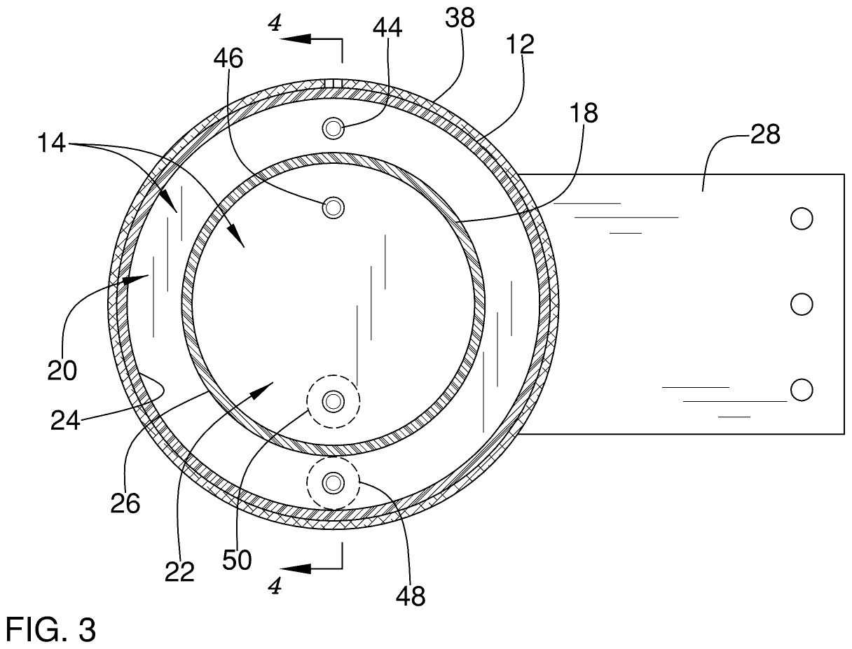

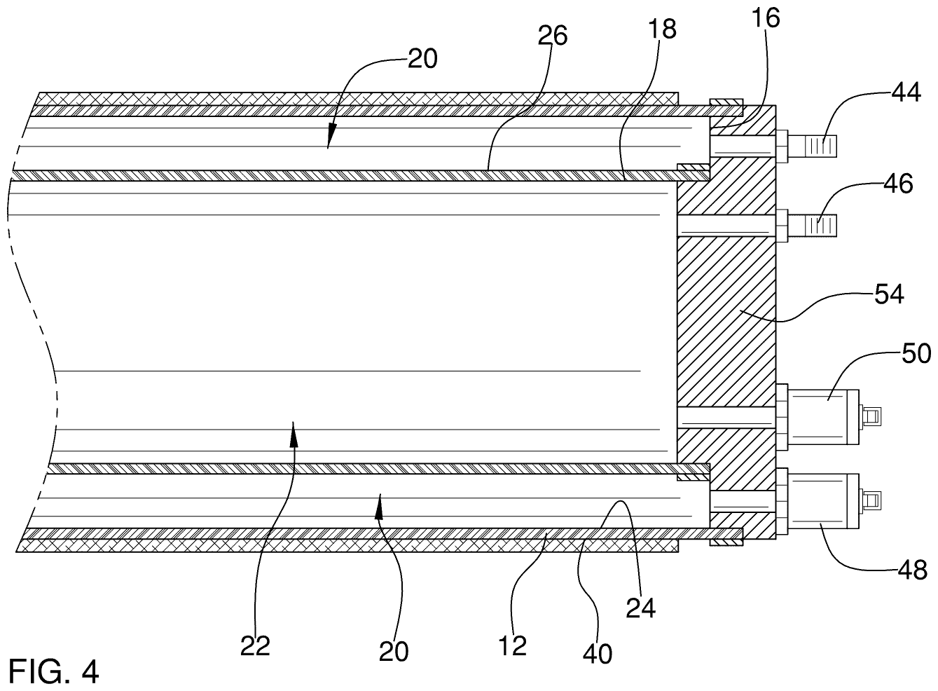

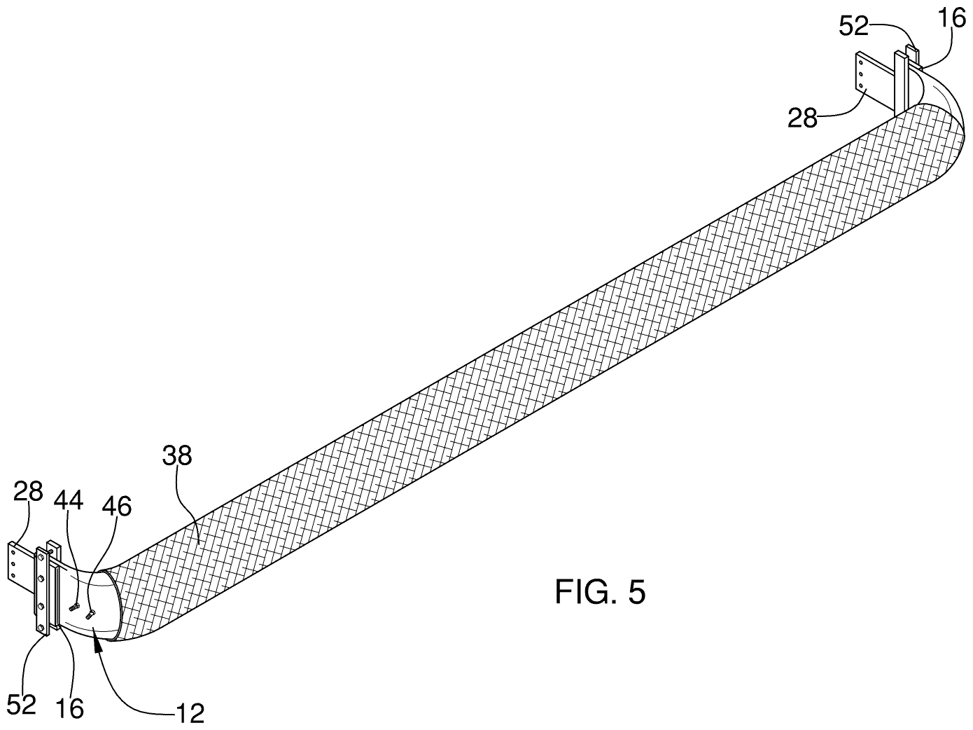

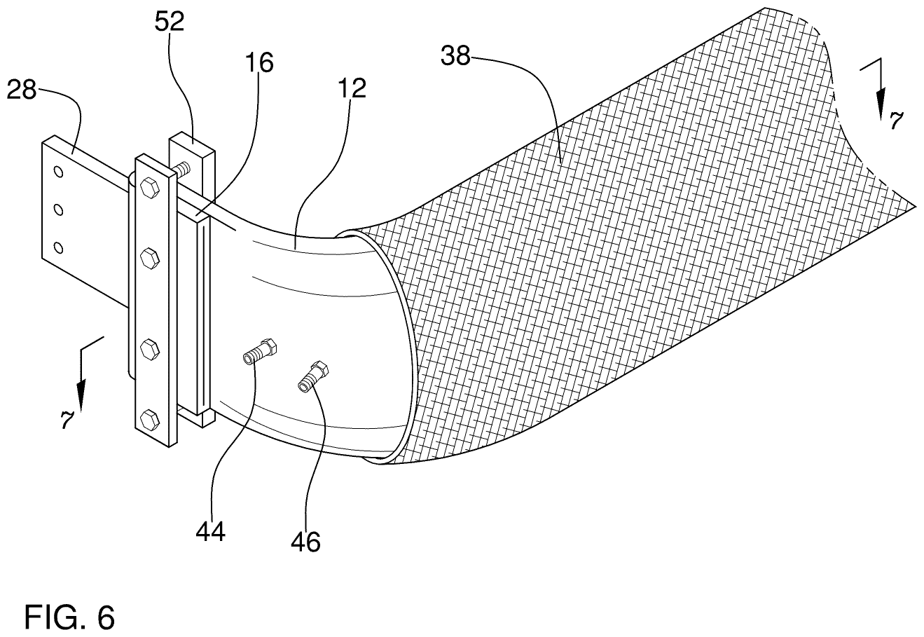

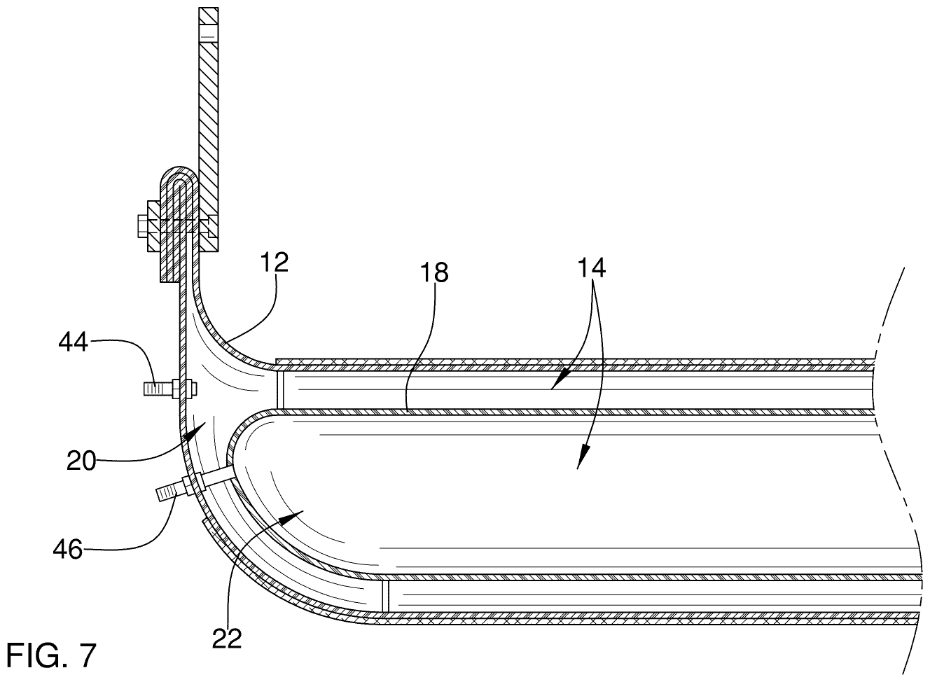

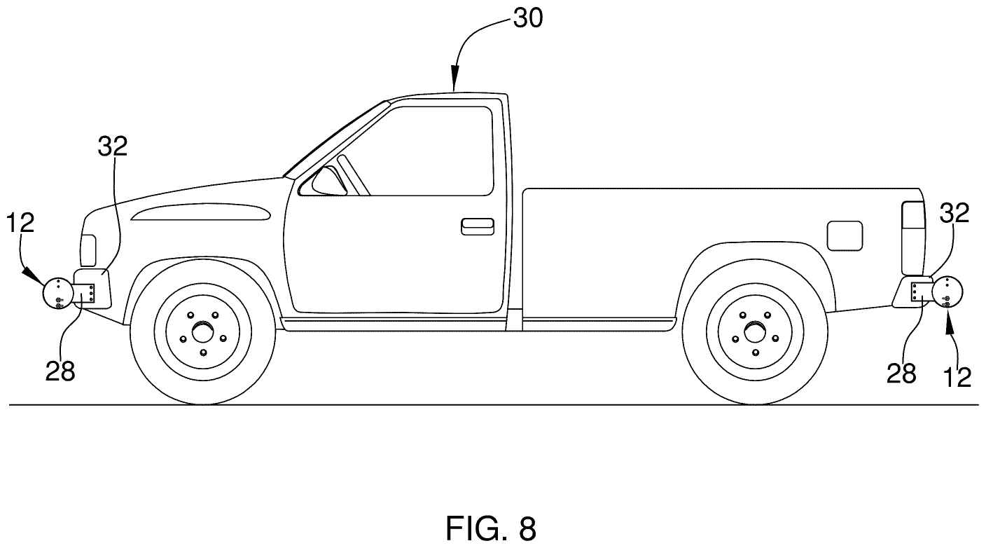

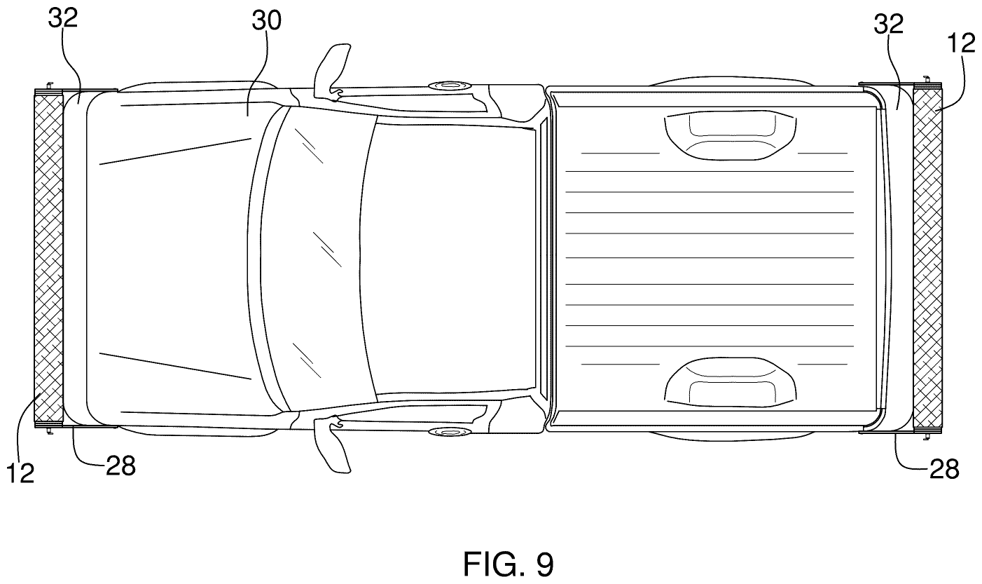

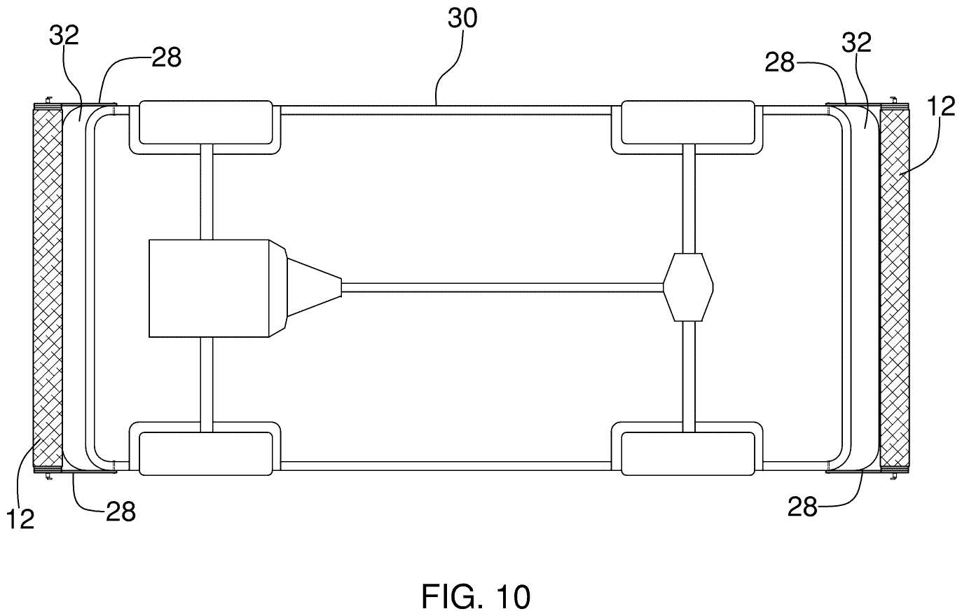

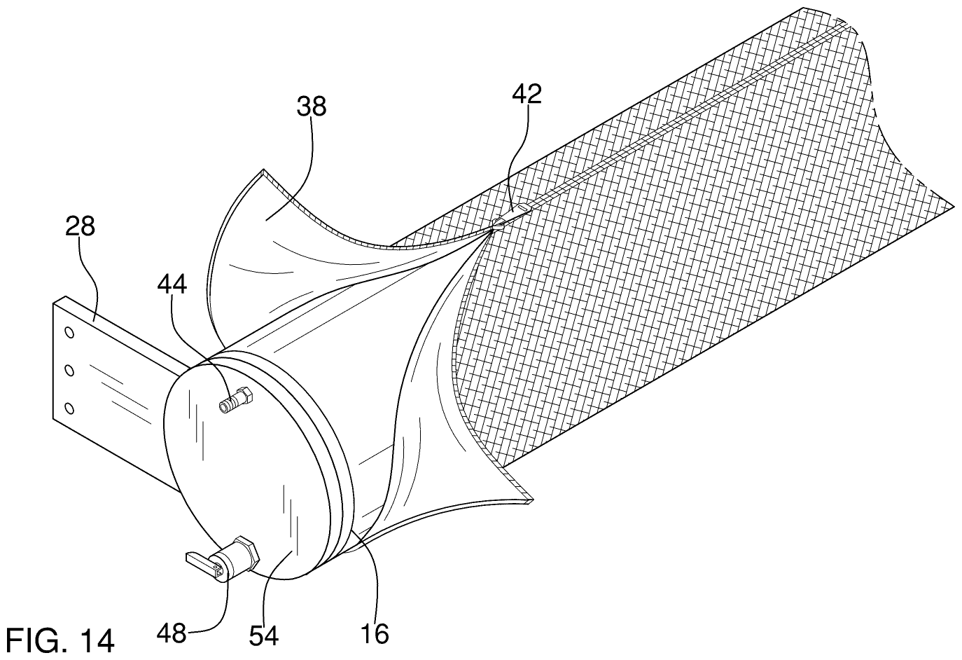

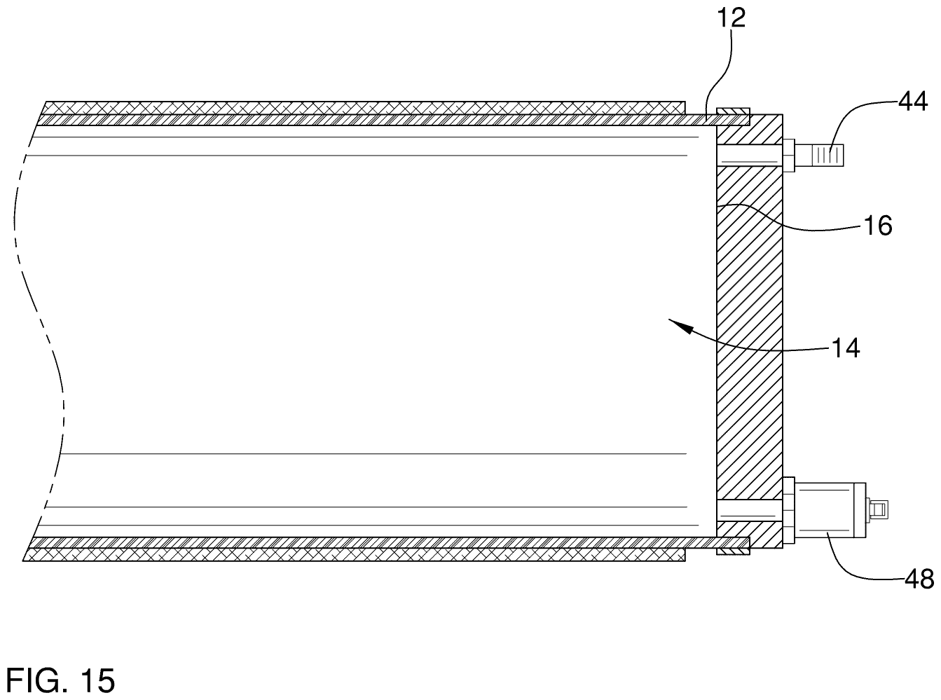

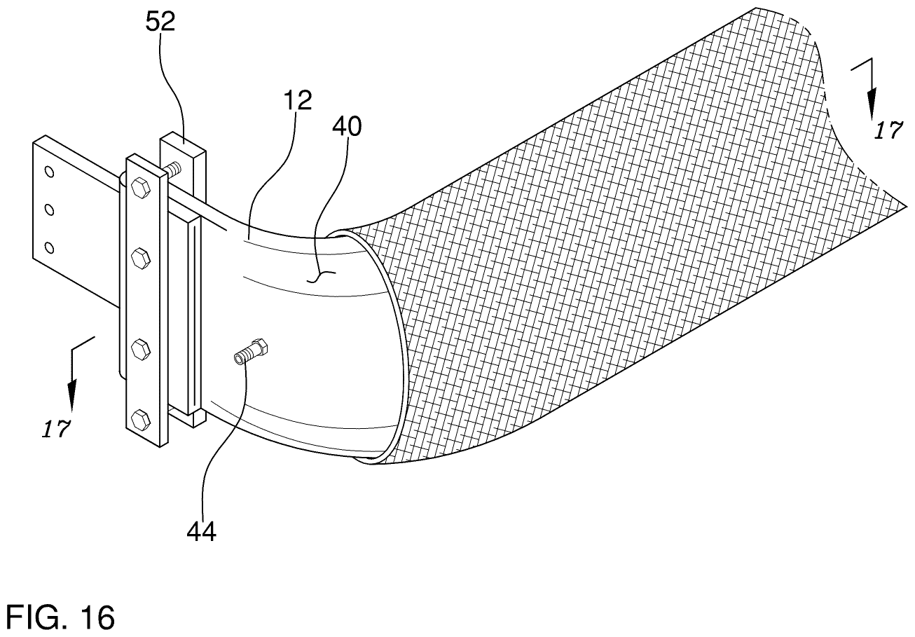

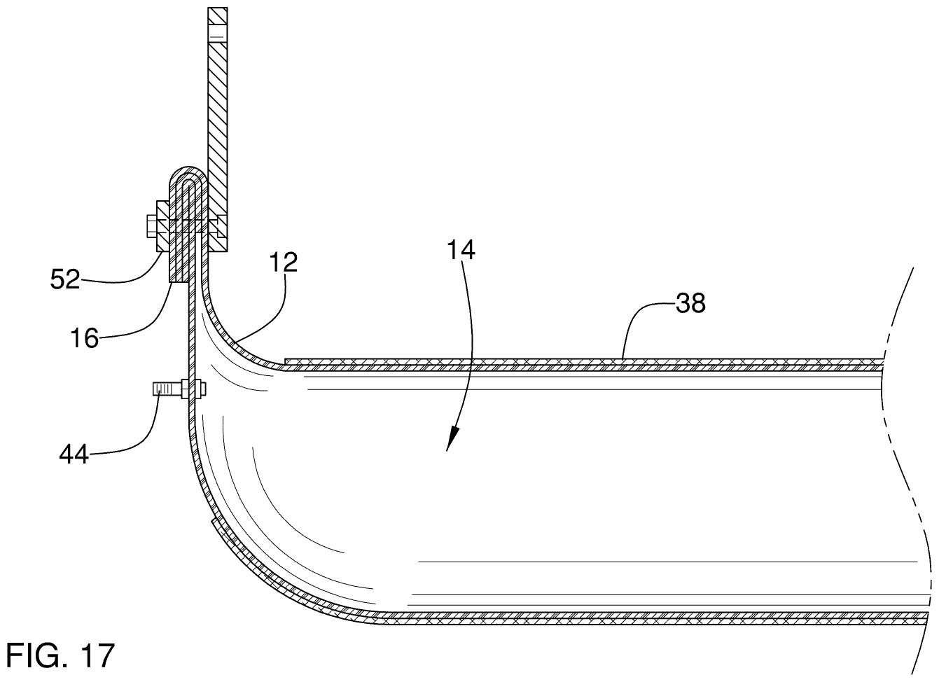

With reference now to the drawings, and in particular to FIGS. 1 through 17 thereof, a new vehicle collision safety device embodying the principles and concepts of an embodiment of the disclosure and generally designated by the reference numeral 10 will be described.

As best illustrated in FIGS. 1 through 17, the vehicle collision impact reduction device 10 generally comprises a tube 12 that defines an interior space 14. The tube 12 is generally configured to hold air within the interior space 14. The tube 12 has a pair of ends 16. An end cap 54 may be coupled to each end of the pair of ends 16. The tube 12 is generally elongated between the pair of ends 16. The tube 12 may be cylindrical. The tube 12 is generally linear between the pair of ends 16. The tube 12 may include a rubber material.

A hose 18 may be positioned within the interior space 14 of the tube 12 wherein the hose 18 defines a first chamber 20 and a second chamber 22 within the interior space 14. Specifically, the hose 18 may have a length that is less than a length of the tube 12 such that the hose 18 is positioned inside the tube 12 to separate the first chamber 20 from the second chamber 22. The first chamber 20 of the interior space 14 may be positioned between an interior surface 24 of the tube 12 and an outer surface 26 of the hose 18. The second chamber 22 of the interior space 14 may be enclosed with the hose 18. The hose 18 is generally elongated. The hose 18 may be linear.

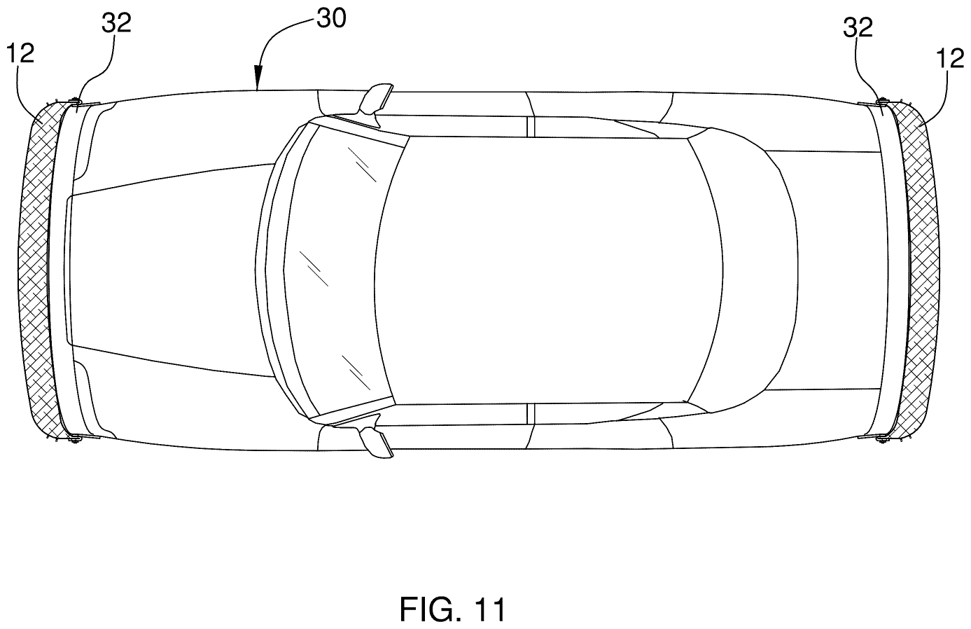

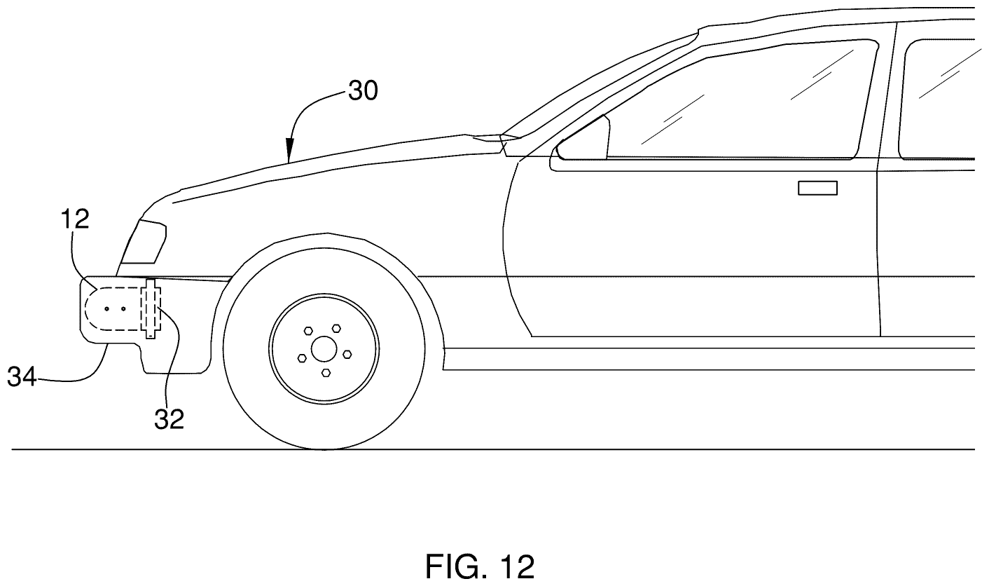

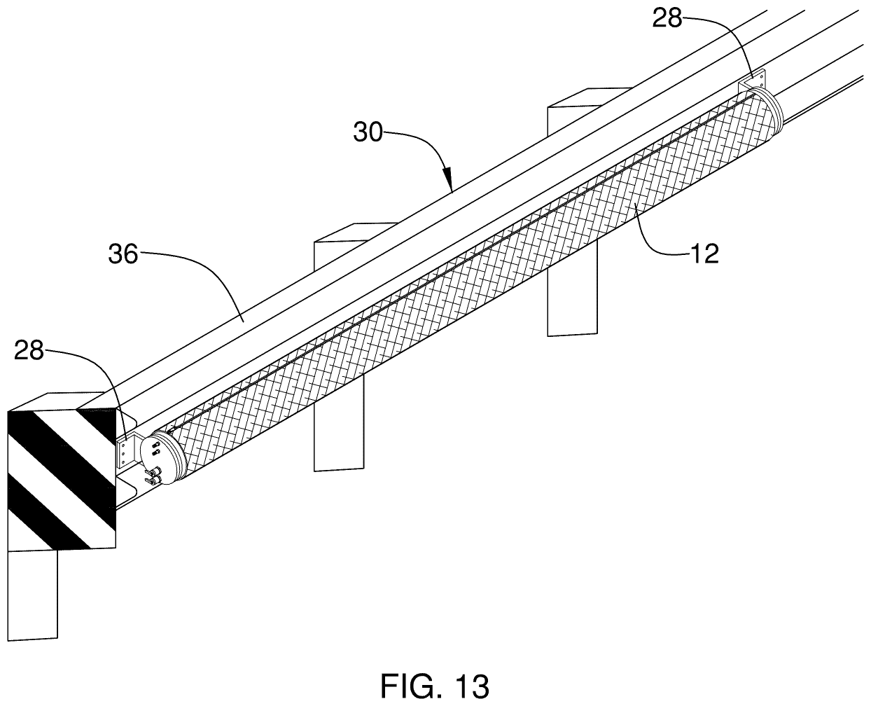

A mount 28 is coupled to each end of the pair of ends 16 of the tube 12. The mount 28 is configured to couple the tube 12 to a structure 30 wherein the tube 12 is configured to absorb force from an impact with the structure 30. For example, the structure 30 may be a vehicle bumper 32 (including the front bumper, the rear bumper, or both) or a guardrail 36 that is positioned alongside a highway, interstate, or other roadway. More specifically, the mount 28 may couple the tube 12 to the vehicle bumper 32 in front of a bumper cover 34, as shown in FIG. 11, or behind the bumper cover 34 of the vehicle bumper 32, as shown in FIG. 12. The mount 28 may also couple the tube 12 onto the guardrail 36 as shown in FIG. 13. In other embodiments, the mount 28 may couple the tube 12 to a vehicle door, or a vehicle side beneath the vehicle door. In yet other embodiments, the mount 28 may couple the tube 12 to a post of a street light, a post of a traffic light, or a post of a traffic sign. The mount 28 may couple the tube 12 to any structure 30 where collisions are likely to occur.

When an object collides with the structure 30, the tube 12 will absorb force from the impact, allowing the object to merely bounce off the structure 30 instead of collapsing or crushing the structure 30. In a more concrete example, when the structure 30 is a vehicle bumper 32 of a vehicle and the vehicle collides with the object, such as an oncoming car, the tube 12 will absorb the force of the impact between the vehicle and the oncoming car. Air pressure within the tube 12 may also push the vehicle and the oncoming car away from each other; The tube 12 may even inhibit damage to the structure 30 (in the preceding example, the vehicle) and the object which collides with the structure 30 (in the preceding example, the oncoming car).

The tube 12 absorbs force from the impact in a similar manner to a traditional air bag, which is deployed inside a cabin of a vehicle after an impact. More specifically, a traditional airbag is normally deflated and stored inside the paneling of doors, the roof lining, the dashboard, the steering wheel, and siding of the vehicle, upon impact the traditional airbag fills with air and expands outwardly toward occupants within the vehicle. The traditional airbag deploys at a very high speed, hitting occupants with a very high amount of force. The speed of the airbag deployment depends, at least partially, on the speed and angle of the impact and whether the occupants are wearing seat belts.

Traditional airbags usually deploy at speeds of least 10-12 miles per hour and can even deploy at speeds of 20 miles per hour or higher. Traditional airbags have to deploy very quickly (typically over a fraction of a second) to minimize the risk of injury to the occupants of the vehicle which can be caused by the force with which the traditional airbags hit the occupants. The fact that traditional airbags injure the occupants because of the force and speed at which the traditional airbag must deploy and collide directly with the occupants is taken as an inescapable factor in traditional vehicle safety devices. The presently disclosed vehicle collision impact reduction device 10 avoids direct collision with occupants of the vehicle, solving the problem of the purportedly inescapable consequence that traditional airbags faced to keep occupants within the vehicle. Conversely, the tube 12 is always filled with air, such that the tube 12 does not need to expand for deployment after the impact. The tube 12 is also positioned outside the passenger compartment of the vehicle, such that the tube 12 does not collide with the occupants during the impact.

A cover 38 is generally coupled to the tube 12. The cover 38 is generally positioned to cover an exterior surface 40 of the tube 12. The cover 38 may include a canvas material wherein the cover 38 is configured to inhibit damage to the tube 12. Canvas materials are known to be highly durable, particularly when the canvas materials are formed by using a tight basket weave. Therefore, the canvas material is preferred to inhibit the tube from being punctured, torn, or otherwise damaged during use.

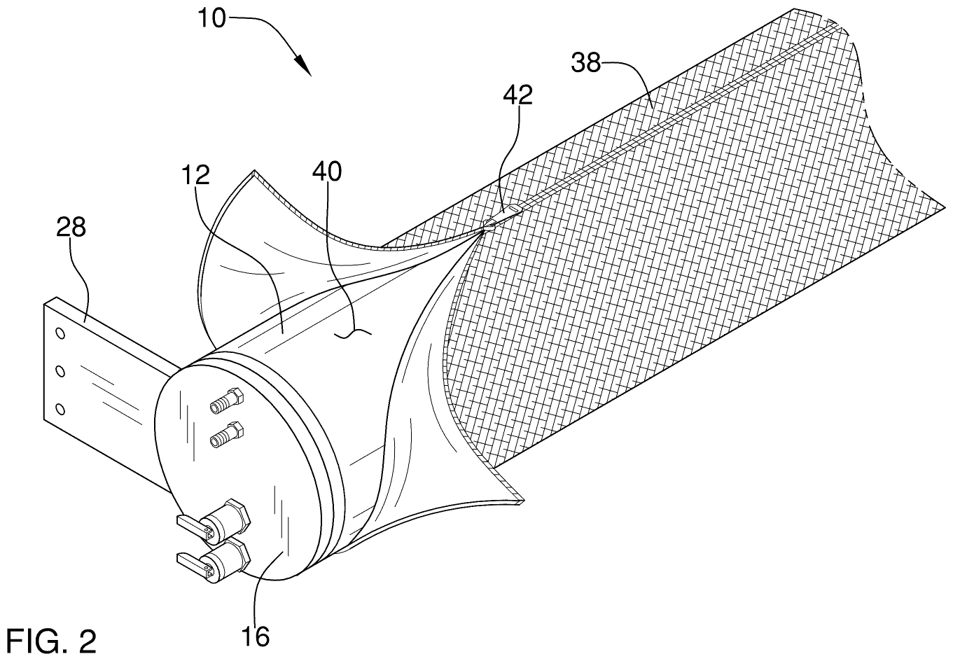

A fastener 42 may be coupled to the cover 38. The fastener 42 is generally engageable to secure the cover 38 around the exterior surface 40 of the tube 12. The fastener 42 is also generally releasable to remove the cover 38 from the tube 12. For example, the cover 38 may be removed from the tube 12 to replace or repair the cover 38. As shown in FIG. 2, the fastener 42 may be a zipper.

A fill valve 44 may be coupled to the tube 12. The fill valve 44 is in fluid communication with the interior space 14. In embodiments including the hose 18, the fill valve 44 is generally in fluid communication with the first chamber 20 of the interior space 14. The fill valve 44 is configured to facilitate increasing an air pressure within the interior space 14, and specifically within the first chamber 20 in embodiments including the hose 18. The fill valve 44 may be positioned on, or proximate to, a first end of the pair of ends 16 of the tube 12. The fill valve 44 may alternatively be positioned proximate to a second end of the pair of ends 16 of the tube. The fill valve 44 is generally positioned proximate to an end of the pair of ends 16 of the tube 12 so that the fill valve 44 is convenient to access when air pressure needs to be increased.

An inlet valve 46 may be coupled to the hose 18. The inlet valve 46 is generally in fluid communication with the second chamber 22 wherein the inlet valve 46 is configured to facilitate increasing the air pressure within the second chamber 22 of the interior space 14. The inlet valve 46 may extend outwardly from the hose 18 through the tube 12, such that the inlet valve 46 is configured to be accessible to a user. For example, the inlet valve 46 may be positioned to extend from the tube 12 proximate to the first end of the pair of ends 16 of the tube 12. Positioning the inlet valve 46 adjacent to the fill valve 44 may make the inlet valve 46 more convenient for the user to access, although this disclosure also contemplates positioning the inlet valve 46 on the second end of the pair of ends 16 of the tube.

An air release valve 48 may be coupled to the tube 12. The air release valve 48 is generally in fluid communication with the interior space 14. For example, in embodiments including the hose 18, the air release valve 48 may be in fluid communication with the first chamber 20 of the interior space 14. The air release valve 48 is generally configured to facilitate release of air from the interior space 14, or the first chamber 20 of the interior space 14, upon impact with the structure 30. For example, particularly in high-speed impacts, the air release valve 48 may open to expel air pressure from the pair of ends 16 of the tube 12, inhibiting the tube 12 from bursting and exploding directly onto the structure 30 or the object which collided with the structure 30, which could damage the structure 30 or the object and potentially cause injury. Accordingly, the air release valve 48 may be positioned on, or proximate to, the first end of the pair of ends 16 of the tube 12 wherein the air release valve 48 is configured to direct air outwardly from the first end of the pair of ends 16 of the tube 12 after impact with the structure 30. In other embodiments, the air release valve 48 may be positioned on, or proximate to, the second end of the pair of ends 16 of the tube 12, for example to distance the air release valve 48 from the fill valve 44 and to allow the hose 18 and the tube 12 to deflate more evenly across the length of the hose 18 and the tube 12.

An outlet valve 50 may be coupled to the hose 18. The outlet valve 50 is generally in fluid communication with the second chamber 22 of the interior space 14 wherein the outlet valve 50 is configured to facilitate release of air from the second chamber 22 upon impact with the structure 30. The outlet valve 50 may extend outwardly from the hose 18 through the tube 12. For example, the outlet valve 50 may be positioned on, or proximate to, the first end of the pair of ends 16 of the tube 12 wherein the outlet valve 50 is positioned on the first end of the pair of ends 16 of the tube 12 adjacent to the fill valve 44 and wherein the outlet valve 50 is configured to direct air outwardly from the first end of the pair of ends 16 of the tube 12 after impact with the structure 30. Alternatively, the outlet valve 50 may be positioned on the second end of the pair of ends 16 of the tube 12 wherein the outlet valve 50 is configured to direct air outwardly from the second end of the pair of ends 16.

The outlet valve 50 may operate the same as, or similarly to, the air release valve 48, releasing air from one of the pair of ends 16 of the tube 12 during particularly high-speed impacts to inhibit the tube 12 from exploding and to inhibit the air from being released forwardly or backwardly directly into the structure 30 or the object which collided with the structure 30. As shown in the figures, the air release valve 48 and the outlet valve 50 may both be positioned on, or adjacent to, the same end of the pair of ends 16 of the tube 12, while in alternative embodiments, the air release valve 48 and the outlet valve 50 may each be positioned on a respective end of the pair of ends 16 of the tube 12.

A pair of clamps 52 may be coupled to the pair of ends 16 of the tube 12 wherein each clamp of the pair of clamps 52 is positioned on a respective end of the pair of ends 16. The pair of clamps 52 generally secure the tube 12 to the mount 28. The pair of clamps 52 may also securely close off the pair of ends 16 of the tube 12 to retain air within the interior space 14.

In use, the tube 12 absorbs impact forces between the structure 30 to which the tube 12 is coupled and the object which collides with the structure 30. As explained above, because the tube 12 is not positioned within the cabin of a vehicle, the tube 12 does not need to hit occupants of the vehicle to absorb impact forces. Instead, impact forces are absorbed outside of the structure 30, before those impact forces can travel through the structure 30 to potentially injure occupants or damage the structure 30 itself. When the structure 30 is a guardrail 36, for example, as shown in 13, and an oncoming car collides with the guardrail 36, the tube 12 may allow the oncoming car to merely bounce off of the guardrail 36. Accordingly, the guardrail 36 would not need to crumple or deform around the oncoming car to absorb the impact forces, reducing the likelihood that the guardrail 36 will need to be repaired or replaced and saving taxpayer money.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle collision impact reduction assembly comprising:
a tube defining an interior space being configured to hold air, the tube having a pair of ends, the tube being elongated between the pair of ends;
a mount being coupled to each end of the pair of ends of the tube wherein the mount is configured to couple the tube to a structure wherein the tube is configured to absorb force from an impact with the structure;
a cover being coupled to the tube, the cover including a canvas material wherein the cover is configured to inhibit damage to the tube; and
a fill valve being coupled to the tube, the fill valve being in fluid communication with the interior space wherein the fill valve is configured to facilitate increasing an air pressure within the interior space.

2. The vehicle collision impact reduction assembly of claim 1, wherein the tube is linear between the pair of ends.

3. The vehicle collision impact reduction assembly of claim 1, further comprising a hose being positioned within the interior space of the tube wherein the hose defines a first chamber and a second chamber within the interior space.

4. The vehicle collision impact reduction assembly of claim 3, wherein the fill valve is in fluid communication with the first chamber of the interior space.

5. The vehicle collision impact reduction assembly of claim 3, further comprising an inlet valve being coupled to the hose, the inlet valve being in fluid communication with the second chamber wherein the inlet valve is configured to facilitate increasing the air pressure within the second chamber of the interior space.

6. The vehicle collision impact reduction assembly of claim 5, wherein the inlet valve extends outwardly from the hose through the tube.

7. The vehicle collision impact reduction assembly of claim 3, further comprising an air release valve being coupled to the tube, the air release valve being in fluid communication with the first chamber wherein the air release valve is configured to facilitate release of air from the first chamber upon impact with the structure.

8. The vehicle collision impact reduction assembly of claim 7, wherein the air release valve is positioned on the first end of the pair of ends of the tube wherein the air release valve is configured to direct air outwardly from the first end of the pair of ends of the tube after impact with the structure.

9. The vehicle collision impact reduction assembly of claim 3, further comprising an outlet valve being coupled to the hose, the outlet valve being in fluid communication with the second chamber of the interior space wherein the outlet valve is configured to facilitate release of air from the second chamber upon impact with the structure.

10. The vehicle collision impact reduction assembly of claim 9, wherein the outlet valve extends outwardly from the hose through the first end of the tube wherein the outlet valve is configured to direct air outwardly from the first end of the pair of ends of the tube after impact with the structure.

11. The vehicle collision impact reduction assembly of claim 1, further comprising a fastener being coupled to the cover, the fastener being engageable to secure the cover around an exterior surface of the tube.

12. The vehicle collision impact reduction assembly of claim 1, further comprising a pair of clamps being coupled to the pair of ends of the tube wherein each clamp of the pair of clamps is positioned on a respective end of the pair of ends, the pair of clamps securing the tube to the mount.

13. The vehicle collision impact reduction assembly of claim 1, further comprising an air release valve being coupled to the tube, the air release valve being in fluid communication with the interior space wherein the air release valve is configured to facilitate release of air from the interior space upon impact with the structure.

14. A vehicle collision impact reduction assembly comprising:
a tube defining an interior space being configured to hold air, the tube having a pair of ends, the tube being elongated between the pair of ends, the tube being cylindrical, the tube being linear between the pair of ends, the tube including a rubber material;
a hose being positioned within the interior space of the tube wherein the hose defines a first chamber and a second chamber within the interior space, the first chamber of the interior space being positioned between an interior surface of the tube and an outer surface of the hose, the second chamber of the interior space being enclosed with the hose;
a mount being coupled to each end of the pair of ends of the tube wherein the mount is configured to couple the tube to a structure wherein the tube is configured to absorb force from an impact with the structure;
a cover being coupled to the tube, the cover being positioned to cover an exterior surface of the tube, the cover including a canvas material wherein the cover is configured to inhibit damage to the tube;
a fastener being coupled to the cover, the fastener being engageable to secure the cover around the exterior surface of the tube, the fastener being releasable to remove the cover from the tube, the fastener being a zipper;
a fill valve being coupled to the tube, the fill valve being in fluid communication with the first chamber wherein the fill valve is configured to facilitate increasing an air pressure within the first chamber of the interior space, the fill valve being positioned proximate to a first end of the pair of ends of the tube;
an inlet valve being coupled to the hose, the inlet valve being in fluid communication with the second chamber wherein the inlet valve is configured to facilitate increasing the air pressure within the second chamber of the interior space, the inlet valve extending outwardly from the hose through the tube wherein the inlet valve is positioned on the first end of the pair of ends of the tube adjacent to the fill valve.

15. The vehicle collision impact reduction assembly of claim 14, further comprising:
an air release valve being coupled to the tube, the air release valve being in fluid communication with the first chamber wherein the air release valve is configured to facilitate release of air from the first chamber upon impact with the structure, the air release valve being positioned on the first end of the pair of ends of the tube wherein the air release valve is configured to direct air outwardly from the first end of the pair of ends of the tube after impact with the structure; and
an outlet valve being coupled to the hose, the outlet valve being in fluid communication with the second chamber of the interior space wherein the outlet valve is configured to facilitate release of air from the second chamber upon impact with the structure, the outlet valve extending outwardly from the hose through the tube wherein the outlet valve is positioned on the first end of the pair of ends of the tube adjacent to the fill valve.

16. The vehicle collision impact reduction assembly of claim 14, further comprising a pair of clamps being coupled to the pair of ends of the tube wherein each clamp of the pair of clamps is positioned on a respective end of the pair of ends, the pair of clamps securing the tube to the mount.

17. The vehicle collision impact reduction assembly of claim 14, wherein the structure is a bumper of a vehicle.

18. The vehicle collision impact reduction assembly of claim 17, wherein the tube is positioned on a bumper cover being positioned over the bumper of the vehicle.

19. The vehicle collision impact reduction assembly of claim 17, wherein the tube is positioned between a bumper cover and the bumper of the vehicle.

20. The vehicle collision impact reduction assembly of claim 14, wherein the structure is a guardrail being positioned on a roadway.
